(19) United States
(12) Patent Application Publication
(10) Pub. No.: US 2024/0332713 A1
(43) Pub. Date: Oct. 3, 2024

(54) Battery Pack Assembly Using Rotating Handle

(71) Applicant: LG Energy Solution, Ltd., Seoul (KR)

(72) Inventor: Jong Yoon Keum, Daejeon (KR)

(73) Assignee: LG Energy Solution, Ltd., Seoul (KR)

(21) Appl. No.: 18/580,362

(22) PCT Filed: Jan. 4, 2023
(86) PCT No.: PCT/KR2023/000132

§ 371 Date: Jan. 18, 2024

(30) Foreign Application Priority Data
Jan. 4, 2022 (KR) 10-2022-0000842

(51) Int. Cl. H01M 50/264; H01M 50/233; H01M 50/244; H01M 50/271

(52) U.S. Cl. CPC H01M 50/264; H01M 50/233; H01M 50/244; H01M 50/271

(57) ABSTRACT

A battery pack assembly includes a rotating handle and an elastic member. The battery pack assembly comprises: a battery pack having a cover on the top; the handle rotatably installed on the top surface of the battery pack cover; and a seat having an inner space for accommodating the battery pack. The elastic member is installed between the inner bottom surface of the seat and the lower surface of the battery pack. The handle has a rod shape and is configured to rotate between an unlock position, in which both ends of the handle are recessed within the top surface of the battery pack cover, and a lock position, in which both ends protrude beyond the top surface. The seat has grooves formed on the top of the inner side surface so that both ends of the handle can be received and fixed therein in the lock position.

### CROSS-REFERENCE TO RELATED APPLICATIONS

The present application is a national phase entry under 35 U.S.C. § 371 of International Application No. PCT/KR2023/000132, filed on Jan. 4, 2023, which claims priority from Korean Patent Application No. 10-2022-0000842, filed on Jan. 4, 2022, all of which are incorporated herein by reference.

### TECHNICAL FIELD

The present disclosure relates to a battery pack assembly, which relates to, particularly, a battery pack assembly having a fixing structure using a rotating handle and an elastic member.

### BACKGROUND ART

Electric vehicles are driven by batteries, and among them, light electric vehicles (LEVs) include two-wheeled vehicles such as electric bicycles and electric scooters. The battery pack of the light electric vehicle may be a replaceable or swappable pack.

FIGS. 1 and 2 show a conventional battery pack assembly, where FIG. 1 is in a state where the seat cover is opened, and FIG. 2 is in a state in which the seat cover is closed.

Referring to FIGS. 1 and 2, a seat (LEV seat) (1) is mounted on a light electric vehicle, a battery pack (2) is mounted on the seat (1), a seat cover (3) is installed on the top of the seat (1), a foam (4) is attached to the lower surface of the seat cover (3), and a connector (5) is installed to the lower part of the battery pack (2).

Referring to FIG. 2, the conventional pack fixing structure is a structure that as a pack fixing method using the compressive force of the foam (4) attached to the seat cover (3), when the seat cover (3) is closed, the foam (4) attached to the seat cover (3) compresses the battery pack (2) from above to be fixed. However, when used repeatedly for a long period of time, the foam (4) is permanently deformed by the compressive force, whereby the compressive force fixing the battery pack (2) may be reduced or weakened. If the force (compressive force) that fixes the pack is reduced or weakened due to compression of the foam, the connector (5) contacts may become weak or the connector (5) contact defects may occur, and the battery pack (2) may be damaged or broken by vibration and shock.

### DISCLOSURE

### Technical Problem

It is an object of the present invention to provide a battery pack assembly capable of maintaining fixation force of the battery pack even when repeatedly used for a long period of time.

### Technical Solution

According to one aspect of the present invention, a battery pack assembly is provided, which comprises: a battery pack having a cover: a handle rotatably installed on the battery pack cover, and rotating between an unlock position where both ends are located inside the battery pack cover and a lock position where both ends protrude outward from the battery pack cover; a seat having an inner space for accommodating a battery pack, provided such that both ends of the handle are inserted at the lock position, and having grooves for inserting both ends of the handle at the lock position; and an elastic member provided in the inner space of the seat and arranged to be compressed when the battery pack is inserted into the inner space.

Specifically, the battery pack assembly related to one example of the present invention may comprise: a battery pack having a cover on the top: a handle rotatably installed on the top surface of the battery pack cover, formed in a rod shape, and rotating between an unlock position where both ends are disposed within the top surface range of the battery pack cover and a lock position where both ends protrude beyond the top surface range of the battery pack cover; a seat having an inner space for accommodating the battery pack, and having grooves formed on the top of the inner side surface so that both ends of the handle are inserted at the lock position and fixed; and an elastic member installed between the inner bottom surface of the seat and the lower surface of the battery pack.

In an aspect of the present invention, when the handle is pressed down in a state where the handle is at the unlock position, the handle may be lowered while the elastic member is compressed by the lowering of the battery pack, and when the handle is rotated to the lock position in a state where the handle is lowered to the groove position of the seat, the battery pack may be fixed to the seat while both ends of the handle are inserted into the grooves of the seat.

In an aspect of the present invention, when the handle is rotated to the unlock position in a state where both ends of the handle are inserted into the grooves of the seat, the battery pack rises by the restoring force of the elastic member to be detachable from the seat while both ends of the handle escape from the grooves of the seat.

In an aspect of the present invention, the groove position of the seat, and the elastic modulus and deformation amount of the elastic member may be set so that the elastic member may be compressed and expanded only within the elastic region.

In an aspect of the present invention, locking jaws limiting the rotation range of the handle at each of the unlock position and the lock position of the handle may be formed on the battery pack cover.

In an aspect of the present invention, the grooves of the seat may be continuously formed in the circumferential direction of the seat by at least the rotation range of the handle along the rotation direction of the handle.

The battery pack assembly according to an aspect of the present invention may further comprise a cap installed at the rotation center of the handle to be capable of preventing rotation of the handle; and a second elastic member installed between the handle and the cap.

In an aspect of the present invention, the cap may comprise an upper member: a rim member extending downward from the rim portion of the upper member: a pair of leg members extending downward from the upper member inside the rim member; and a protruding member extending outward in the lateral direction from the lower portion of the leg members.

In an aspect of the present invention, the handle may comprise a second groove into which the rim member of the cap is inserted: a hole into which the leg members of the cap are inserted: a vertical member sandwiched between the pair of leg members of the cab: a supporting member extending outward in the lateral direction from the lower portion of the vertical member; and a third groove formed on the supporting member and into which the protruding member of the cap is inserted.

In an aspect of the present invention, the battery pack cover may comprise a handle mounting member installed at the rotation center of the handle: wherein the handle mounting member may comprise a first accommodating part accommodating the supporting member of the handle: a second accommodating part accommodating the vertical member of the handle and the leg members of the cap; and a second locking jaw installed in the second accommodating part and limiting rotation of the protruding member of the cap.

In an aspect of the present invention, in a state where the handle is at the unlock position, the protruding member of the cap is caught on the second locking jaw, so that the rotation of the handle can be prevented.

In an aspect of the present invention, when the cap is pressed down in a state where the handle is at the unlock position, the protruding member of the cap escapes the second locking jaw and is inserted into the third groove of the handle while the second elastic member is compressed, so that the rotation of the handle is possible.

### Advantageous Effects

The battery pack assembly of the present disclosure can maintain, as a pack fixing method using the compressive force of an elastic member, fixation force of the battery pack even when repeatedly used for a long period of time.

Also, by adopting a method of fixing the battery pack using the rotating handle and the compressive force of the elastic member inside the seat, additional parts are not required.

In addition, by applying the cap structure to the handle, it is possible to prevent the handle from rotating in a state where the battery pack is separated from the seat.

### DESCRIPTION OF DRAWINGS

FIG. 1 shows a conventional battery pack assembly, which shows a state where a seat cover is opened.

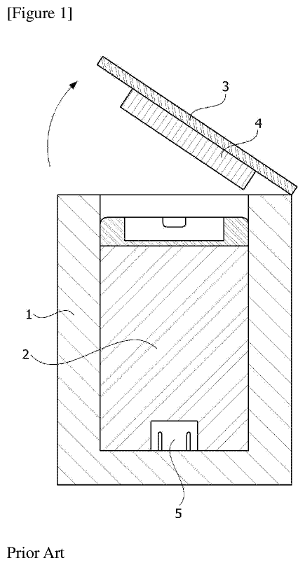

FIG. 2 shows a conventional battery pack assembly, which shows a state where the seat cover is closed.

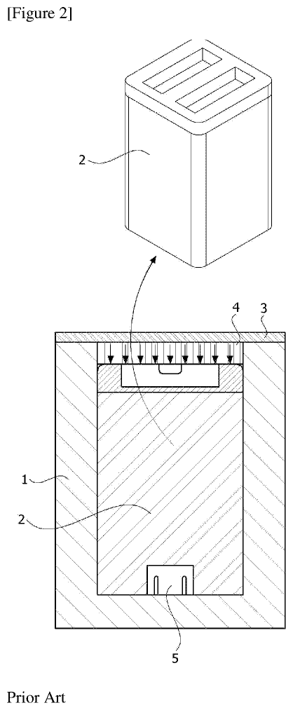

FIG. 3 shows a battery pack assembly according to an embodiment of the present invention, which shows an unlocked state.

FIG. 4 shows a battery pack assembly according to an embodiment of the present invention, which shows a locked state.

FIG. 5 shows a battery pack, a handle, and a cap in an unlocked state according to an embodiment of the present invention, wherein the third diagram is a cross-sectional diagram along line A-A of the second diagram.

FIG. 6 shows a battery pack, handle, and cap in a locked state according to an embodiment of the present invention, wherein the third diagram is a cross-sectional diagram along line B-B of the second diagram.

FIG. 7 shows an anti-rotation structure by interference between a cap and a cover according to an embodiment of the present invention.

### MODE FOR INVENTION

Hereinafter, embodiments of the present invention will be described in detail with reference to the accompanying drawings.

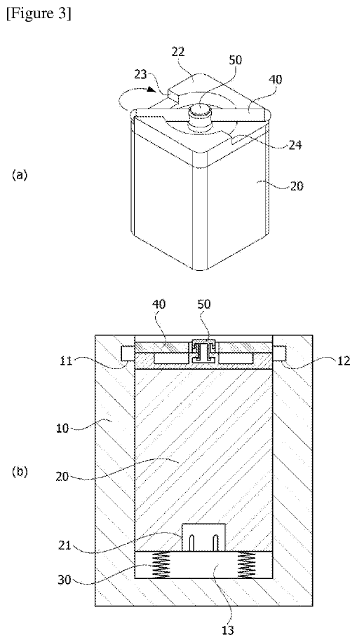

FIG. 3 shows a battery pack assembly according to an embodiment of the present invention, which shows an unlocked state. FIG. 3(a) is a perspective diagram of the battery pack assembly, and FIG. 3(b) is a cross-sectional diagram of the battery pack assembly.

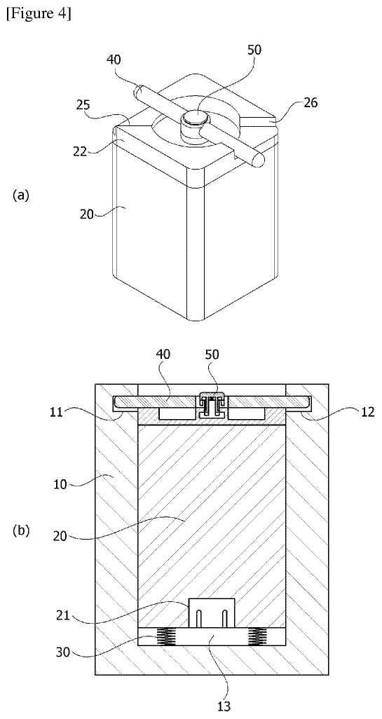

FIG. 4 shows a battery pack assembly according to an embodiment of the present invention, which shows a locked state. FIG. 4(a) is a perspective diagram of the battery pack assembly, and FIG. 4(b) is a cross-sectional diagram of the battery pack assembly.

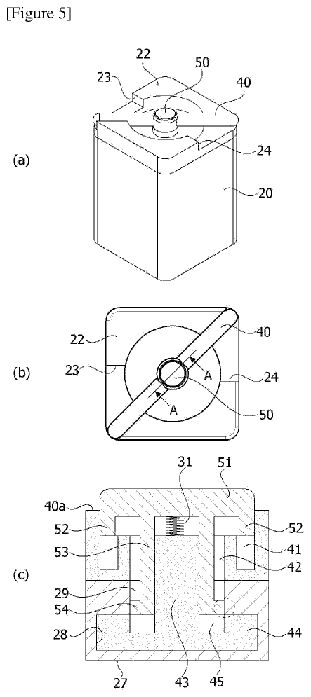

FIG. 5 shows a battery pack, a handle, and a cap in an unlocked state according to an embodiment of the present invention. FIG. 5(a) is a perspective diagram of the battery pack assembly, FIG. 5(b) is a plan view of the battery pack assembly, and FIG. 5(c) is a cross-sectional diagram along line A-A of FIG. 5(b).

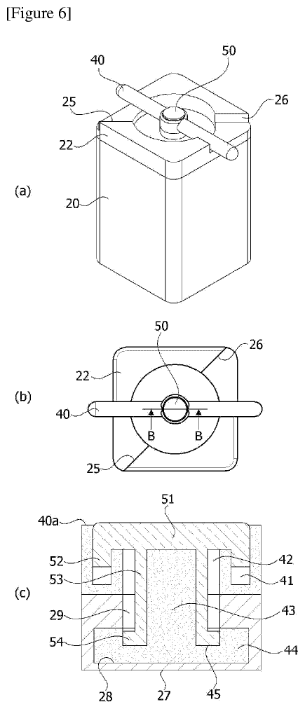

FIG. 6 shows a battery pack, a handle, and a cap in a locked state according to an embodiment of the present invention. FIG. 6(a) is a perspective diagram of the battery pack assembly, FIG. 6(b) is a plan view of the battery pack assembly, and FIG. 6(c) is a cross-sectional diagram along line B-B of FIG. 6(b).

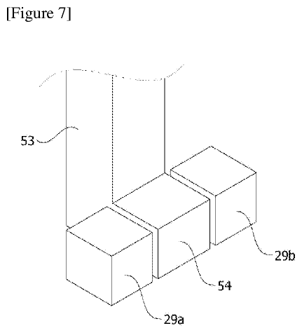

In addition, FIG. 7 shows an anti-rotation structure by interference between a cap and a cover according to an embodiment of the present invention.

Referring to 3 to 7, the battery pack assembly according to an embodiment of the present invention may comprise a seat (10), first grooves (11, 12), a seat inner space (13), a battery pack (20), a connector (21), a battery pack cover (22), first locking jaws (23, 24, 25, 26), a handle mounting member (27), a first accommodating part (28), a second accommodating part (29), second locking jaws (29a, 29b), a first elastic member (30), a second elastic member (31), a handle (40), a handle body (40a), a second groove (41), a hole (42), a vertical member (43), a supporting member (44), a third groove (45), a cap (50), an upper member (51), a rim member (52), a leg member (53), and a protrusion member (54).

The seat (10) may be mounted on an electric vehicle, for example, a light electric vehicle (LEV). The seat (10) has an inner space (13) accommodating the battery pack (20), where the inner space (13) has a shape such as a hexahedron corresponding to the battery pack (20) and a size (volume) corresponding to the battery pack (20).

The first grooves (11, 12) may be formed on the upper part of the inner side surface of the seat (10): both ends of the handle (40) may be inserted and fixed into the first grooves (11, 12) at a lock position; and the first grooves (11, 12) may have a thickness corresponding to that of the handle (40). A total of two first grooves (11, 12) may be formed one by one on both inner side surface of the seat (10) facing each other, which may be formed by extending outward in the lateral direction from the inner side surface. The positions of the first grooves (11, 12), especially the positions in the height direction, may be appropriately set so that the first elastic member (30) may compress and expand (restore) only within the elastic region.

The first grooves (11, 12) may be continuously formed in the circumferential direction of the seat (10) by at least a rotation range (from an unlock position to a lock position) of the handle (40) along the rotation direction of the handle (40). Specifically, the first grooves (11, 12) start to just pass through the unlock position of the handle (40) and are formed to the lock position of the handle (40), provided that the width (lateral direction) of the first grooves (11, 12) may reach a maximum width at the lock position of the handle (40) while gradually increasing along the circumferential direction of the seat (10).

The battery pack (20) may have a shape of a polyhedron such as a hexahedron illustrated in the drawings, or an elliptical cylinder, and the like, where a plurality of batteries may be embedded therein, a connector (21) may be installed at the bottom, and a cover (22) may be provided on the top.

The handle (40) may be rotatably installed on the top surface of the battery pack cover (22). Here, the top surface may be interpreted as including all visible surfaces when the cover (22) is viewed from above. Specifically, it may be interpreted as including all the top surface of the protruding portion forming the first locking jaws (23, 24, 25, 26), the top surface of the rotation region in contact with the handle (40), and the top surfaces of the circular grooves in the form recessed at a predetermined radius from the center of the cover (22).

The top surface of the cover (22) may preferably be formed in a quadrangle (square, rectangle, diamond, etc.), as illustrated when viewed from above, but when both ends of the handle (40) can be disposed within the top surface range of the cover (22) at the unlock position, and both ends of the handle (40) can protrude out of the top surface range of the cover (22) at the lock position, the top surface shape of the cover (22) is not particularly limited, and for example, is also allowably a polygon or an ellipse, provided that in the case of a circular shape, it cannot be adopted because both ends of the handle (40) cannot protrude out of the top surface range.

In this document, the top surface range of the cover (22) means the inside of the cover (22) when the cover (22) is viewed from the top. That is, the meaning that both ends of the handle (40) are disposed within the top surface range of the cover (22) at the unlock position means that when the cover is viewed from the top at the unlock position, both ends of the handle (40) are located at the inside of the cover (22). In addition, the meaning that both ends of the handle (40) protrude out of the top surface range of the cover (22) at the lock position means that when the cover (22) is viewed from the top at the lock position, both ends of the handle (40) protrude to the outside of the cover (22) to be located.

The plurality of first locking jaws (23, 24, 25, 26) limiting the rotation range of the handle (40) at each of the unlock position and the lock position of the handle (40) may be formed on the top surface portion of the cover (22). A pair of locking jaws (23, 24) may restrict the handle (40) at the lock position, and another pair of locking jaws (25, 26) may restrict the handle (40) at the unlock position.

The first locking jaws (23, 24, 25, 26) may be formed by protruding a part of the top surface portions of the cover (22) upward to form protruding portions. As illustrated in the drawings, the protruding portions may be formed in two over a wide range, or may be formed in four over a narrow range, on both opposite corner sides.

In addition, as illustrated in the drawings, a circular groove recessed at a predetermined radius from the center of the cover (22) may be formed on the top surface portion of the cover (22). As the circular groove is formed, the handle (40) can be easily manipulated, and the handle (40) can rotate smoothly.

The regions other than the protruding portion and the circular groove may be a rotation region in which the handle (40) rotates while contacting the cover (22). In the height direction, the protruding portion is at the highest position, the rotation region is at the middle height, and the circular groove is at the lowest position. However, the constitution of the protruding portion, the circular groove, and the rotation region is not limited thereto, which may be appropriately changed as needed.

The first elastic member (30) may be installed between the inner bottom surface of the seat (10) and the lower surface of the battery pack (20), and may be fixed to at least any one or both two of the seat (10) and the battery pack (20), or may be installed without fixing. In an embodiment of the present invention, a pack fixing method using the compressive force of the first elastic member (30) is adopted. The elastic modulus and the deformation amount of the first elastic member (30) may be appropriately set so that the first elastic member (30) may be compressed and expanded (restored) only within the elastic region.

The handle (40) may be rotatably installed on the top surface of the battery pack cover (22), may be formed in a bar shape (circle, ellipse, polygon, etc. on a cross-sectional basis), and may rotate between the unlock position where both ends are disposed within the top surface range of the battery pack cover (22) and the lock position where both ends protrude (stick out) out of the top surface range of the battery pack cover (22).

The rotation angle of the handle (40) may be, for example, 10 to 90 degrees, preferably 20 to 70 degrees, more preferably 30 to 60 degrees, and most preferably 45±5 degrees. The length of the protruding portion of the handle (40) deviating from the top surface of the cover (22) may be, for example, 5 to 40%, preferably 10 to 30%, more preferably 15 to 25% based on the total length of the handle (40).

The rotation center of the handle (40) may be the center of the cover (22). As illustrated in the drawing, when the cover (22) is formed in a quadrangle, the unlock position of the handle (40) may lie on the diagonal of the quadrangle, and the lock position of the handle (40) may lie on the perpendicular bisector of two opposite sides of the quadrangle.

Looking at the fixing (locking) process of the battery pack (20), when the handle (40) is pressed down in a state where the handle (40) is at the unlock position, the handle (40) may be lowered while the first elastic member (30) is compressed by the lowering of the battery pack (20), and when the handle (40) is rotated to the lock position in a state where the handle (40) is lowered to the position of the first grooves (11, 12) of the seat (10), the battery pack (20) may be fixed to the seat (10) while both ends of the handle (40) are inserted into the first grooves (11, 12) of the seat (10).

Looking at the unfixing (unlocking, opening, releasing) process of the battery pack (20), when the handle (40) is rotated to the unlock position in a state where both ends of the handle (40) are inserted into the first grooves (11, 12) of the seat (10), the battery pack (20) may be lifted by the restoring force of the first elastic member (30) to be separated from the seat (10) while both ends of the handle (40) are out of the first grooves (11, 12) of the seat (10).

Referring to FIGS. 5 and 6, the battery pack assembly according to an embodiment of the present invention may further comprise a cap (50) installed at the rotation center of the handle (40) and capable of preventing the rotation of the handle (40); and a second elastic member (31) installed between the handle (40) and the cap (50).

The second elastic member (31) may be installed between the handle (40) and the cap (50), may be fixed to at least any one or both two of the handle (40) and the cap (50), or may be installed without fixing.

The cap (50) may be configured in an approximately II-character shape wholly, and may comprise, specifically, an upper member (51): a rim member (52) extending downward from the rim portion of the upper member (51): a pair of leg members (53) extending downward from the upper member (51) in the inside of the rim member (52); and a protruding member (54) extending outward in the lateral direction from the lower portion of the leg members (53).

The upper member (51) may be composed of a disk or the like. The rim member (52) may be formed on all or only a part of the rim portion of the upper member (51), and may extend downward relatively shorter than the leg members (53). The leg members (53) may extend downward relatively longer than the rim member (52), and may be configured as a pair symmetrically based on the rotation center and at a predetermined interval from the rotation center. The protruding member (54) may extend shortly outward in the lateral direction from the lower portion of the respective leg members (53).

Referring to FIG. 7, in order to prevent rotation of the handle (40), at least the movement of the protruding member (54) must be interfered by the handle mounting member (27) of the cover (22), and to this end, the leg members (53) and the protruding member (54) must be formed only partially along the circumferential direction of the cap (50) in the rotation direction of the handle (40).

The handle (40) may comprise a second groove (41) into which the rim member (52) of the cap (50) is inserted: a hole (42) into which the leg members (53) of the cap (50) are inserted: a vertical member (43) sandwiched between the pair of leg members (53) of the cap (50): a supporting member (44) extending outward in the lateral direction from the lower portion of the vertical member (43); and a third groove (45) formed on the supporting member (44) and into which the protruding member (54) of the cap (50) is inserted.

The second groove (41) may be formed in the vertical direction from the top to the bottom of the handle body (40a), may have the position, shape and size corresponding to those of the rim member (52), and may be formed longer than the rim member (52).

The hole (42) may be formed by penetrating the handle body (40a) from the inside of the second groove (41) in the vertical direction from the top to the bottom so that the leg members (53) and the protruding member (54) may penetrate to enter the supporting member (44). The hole (42) may have the position, shape, and size corresponding to those of the leg members (53) and the protruding member (54).

The vertical member (43) connects the handle body (40a) and the supporting member (44), serves to fix the leg members (53), and serves as a rotating shaft as well. The vertical member (43) has the same width as the spacing between the pair of leg members (53), so that the pair of leg members (53) may fit into the vertical member (43).

The supporting member (44) allows mounting the handle (40) to the handle mounting member (27) of the cover (22), serves to substantially support the entire handle (40), and serves as a rotating shaft as well. The supporting member (44) may have a wider width than the vertical member (43) within the width range of the handle mounting member (27).

The third groove (45) may be formed above the supporting member (44) and may have the position, shape, and size corresponding to those of the pair of protruding members (54).

The battery pack cover (22) may comprise a handle mounting member (27) installed at the rotation center of the handle (40). In addition, the handle mounting member (27) may comprise a first accommodating part (28) for accommodating the supporting member (44) of the handle (40), a second accommodating part (29) for accommodating the vertical member (43) of the handle (40) and the leg members (53) of the cap (50), and second locking jaws (29a, 29b) installed in the second accommodating part (29) and limiting rotation of the protruding member (54) of the cap (50).

The handle mounting member (27) may serve to rotatably support the handle (40), may protrude from the top surface portion of the cover (22) at the rotation center of the handle (40) to be formed, and may be formed in a cylindrical shape or the like.

The first accommodating part (28) is a space with a relatively large volume accommodating the supporting member (44) of the handle (40). The second accommodating part (29) is opened upward, is a space with a relatively large volume accommodating the vertical member (43) of the handle (40), and the leg members (53) and the protruding member (54) of the cap (50), and has a smaller width than that of the first accommodating part (28). The second accommodating part (29) may be continuously formed in the circumferential direction of the handle mounting member (27) by at least the rotation range of the handle (40) along the rotation direction of the handle (40).

The second locking jaws (29a, 29b) may be installed in the second accommodating part (29), for example, directly above the third groove (45) of the handle (40), and for example, as illustrated in FIG. 7, they may be configured of one pair for each protruding member (54), a total of two pairs. However, the position and number, and shape and size of the second locking jaws (29a, 29b) may be appropriately changed as needed.

FIGS. 5 and 7 show an anti-rotation structure by interference between the cap (50) and the cover (22), wherein in a state where the handle (40) is at the unlock position, the protruding member (54) of the cap (50) is caught on the second locking jaws (29a, 29b) of the handle mounting member (27) of the cover (22), so that the rotation of the handle (40) can be prevented. When the cap (50) is not pressed, the cap (50) is always placed in this interference state.

Referring to FIG. 6, when the cap (50) is pressed down in a state where the handle (40) is at the unlock position, the protruding member (54) of the cap (50) goes down while the second elastic member (31) is compressed, and thus escapes the second locking jaws (29a, 29b) and is inserted into the third groove (45) of the handle (40), so that the handle (40) can be rotated.

In this way, it has a structure that when the cap (50) is pressed, the handle (40) is rotatable, and specifically, when the cap (50) is pressed, the battery pack (20) is also pressed and simultaneously the handle (40) is also rotatable.

When the battery pack (20) is fixed to the first grooves (11, 12) of the seat (10), and then the pressed cap (50) is released, the state of FIG. 5 can be restored while the cap (50) goes up by the restoring force of the second elastic member (31).

As described above, the fixing structure according to an embodiment of the present invention has the rotating handle, the elastic member on the bottom surface of the seat, and the grooves of the seat inside, into which the rotating handle can be inserted, as essential components, where the cap structure for preventing the handle from rotating when the battery pack has been separated may be optionally applied.

By applying the pack fixing method using the compressive force in the elastic region of the elastic member on the bottom surface of the seat, and specifically, applying the structure that the rotatable handle of the battery pack is inserted into the grooves at the top end of the seat and compresses the elastic member at the bottom end of the seat to fix the battery pack, the compressive force within the elastic region of the elastic member is used even if used for a long time, so that an embodiment of the present invention can maintain the compressive force for fixing the battery pack constant, and also prevent connector contact defects and damage to the pack due to vibration/shock.

Also, in an embodiment of the present invention, the compressive force for fixing the battery pack can be maintained even when repeatedly used for a long period of time by considering the elastic modulus and the deformation amount so that the elastic member at the bottom end of the seat can be compressed/expanded only within the elastic region.

### INDUSTRIAL APPLICABILITY

The battery pack assembly of an embodiment of the present invention can maintain the fixing force of the battery pack even when repeatedly used for a long period of time as the pack fixing method using the compressive force of the elastic member.

1. A battery pack assembly comprising:
a battery pack having a cover;
a handle rotatably installed on the battery pack cover and configured to rotate between an unlock position and a lock position, wherein in the unlock position both ends of the handle are recessed inside the battery pack cover, and wherein in the lock position both ends of the handle protrude outward from the battery pack cover;
a seat having an inner space for accommodating the battery pack and having a plurality of grooves configured to receive both ends of the handle, respectively, in the lock position; and
an elastic member provided in the inner space of the seat and arranged to be compressed in a state when the battery pack is inserted into the inner space.

2. The battery pack assembly according to claim 1, wherein
in a state in which the handle is in the unlock position and is pressed down, the handle is lowered while the elastic member is compressed by a lowering of the battery pack, and
in a state in which the handle is rotated to the lock position, in which the handle is lowered to a groove position of the seat, the battery pack is fixed to the seat while both ends of the handle are received by the plurality of grooves.

3. The battery pack assembly according to claim 2, wherein
in a state in which the handle is rotated to the unlock position, the battery pack rises by a restoring force of the elastic member, so as to be detachable from the seat while both ends of the handle move out of the plurality of grooves.

4. The battery pack assembly according to claim 1, wherein
a groove position of the seat, an elastic modulus of the elastic member, and a deformation amount of the elastic member are configured so that the elastic member may be compressed and expanded only within an elastic region of the elastic member.

5. The battery pack assembly according to claim 1, wherein
a plurality of locking jaws are disposed on the battery pack cover, so as to limit a rotation range of the handle at each of the unlock position and the lock position.

6. The battery pack assembly according to claim 1, wherein
the plurality of grooves of the seat continuously extend in a circumferential direction of the seat, and
wherein the plurality of grooves are disposed in at least a rotation range of the handle that extends along a rotation direction of the handle.

7. The battery pack assembly according to claim 1, further comprising:
a cap installed at a rotation center of the handle and configured to prevent the rotation of the handle; and
a second elastic member installed between the handle and the cap.

8. The battery pack assembly according to claim 7, wherein
the cap comprises:
an upper member;
a rim member extending from a rim portion of the upper member toward the inner space in a longitudinal direction;
a pair of leg members extending from the upper member toward the inner space, wherein the upper member is disposed closer to the rotation center than the rim member; and
a protruding member extending outward from a lower portion of the leg members, wherein the protruding member extends transverse to the longitudinal direction.

9. The battery pack assembly according to claim 8, wherein
the handle comprises:
a second groove configured to receive the rim member;
a hole configured to receive the pair of leg members;
a vertical member disposed between the pair of leg members;
a supporting member extending outward from a lower portion of the vertical member; wherein the supporting member extends transverse to the longitudinal direction; and
a third groove recessed in the supporting member and configured to receive the protruding member.

10. The battery pack assembly according to claim 9, wherein
the battery pack cover comprises a handle mounting member installed at the rotation center of the handle;
wherein
the handle mounting member comprises:
a first accommodating part accommodating the supporting member;
a second accommodating part accommodating the vertical member and the pair of leg members; and
a second locking jaw installed in the second accommodating part and configured to limit a rotation of the protruding member of the cap.

11. The battery pack assembly according to claim 10, wherein
in a state in which the handle is at the unlock position, the protruding member of the cap is coupled with the second locking jaw, so that the rotation of the handle is prevented.

12. The battery pack assembly according to claim 10, wherein
in the state in which the cap is pressed down when the handle is at the unlock position, the protruding member of the cap uncouples from the second locking jaw and is received by the third groove of the handle while the second elastic member is compressed, so that the rotation of the handle is possible.
